(19) United States
(12) Patent Application Publication
(10) Pub. No.: US 2023/0082395 A1
(43) Pub. Date: Mar. 16, 2023

(54) DEVICE, SYSTEM, AND METHOD FOR BLOCK ACKNOWLEDGEMENT (ACK) (BA) OPERATIONS

(71) Applicant: NXP USA, Inc., Austin, TX (US)

(72) Inventors: Liwen Chu, San Ramon, CA (US); Hongyuan Zhang, Fremont, CA (US); Huiling Lou, Sunnyvale, CA (US)

(21) Appl. No.: 17/944,776

(22) Filed: Sep. 14, 2022

Related U.S. Application Data
(60) Provisional application No. 63/243,910, filed on Sep. 14, 2021.
(60) Provisional application No. 63/262,707, filed on Oct. 19, 2021.
(60) Provisional application No. 63/263,353, filed on Nov. 1, 2021.
(60) Provisional application No. 63/264,165, filed on Nov. 16, 2021.

(51) Int. Cl. H04W 28/18; H04L 1/00; H04L 1/16; H04W 12/106; H04W 12/037

(52) U.S. Cl. CPC H04W 28/18; H04L 1/0057; H04L 1/1628; H04W 12/106; H04W 12/037

(57) ABSTRACT

Embodiments of a device, a method, and a system for Block Acknowledgement (Ack) (BA) operations are disclosed. In an embodiment, the device includes a wireless network interface device implemented on one or more integrated circuits (ICs), where the wireless network interface device is configured to negotiate a BA agreement for multiple links, where the BA agreement includes a managed scoreboard context and a managed reorder buffer, and exchange frames according to the BA agreement.

### CROSS-REFERENCE TO RELATED APPLICATIONS

This application is entitled to the benefit of U.S. Provisional Patent Application Ser. No. 63/243,910, filed on Sep. 14, 2021, U.S. Provisional Patent Application Ser. No. 63/262,707, filed on Oct. 19, 2021, U.S. Provisional Patent Application Ser. No. 63/263,353, filed on Nov. 1, 2021, and U.S. Provisional Patent Application Ser. No. 63/264,165, filed on Nov. 16, 2021, each of which is incorporated by reference herein.

### BACKGROUND

In wireless communications, wireless devices, e.g., multi-link devices (MLDs), can execute various multi-link operations, such as transmission and reception of frames via one or more communication links. As an example, MLDs may establish a Block Acknowledgement (Ack) (BA) agreement when exchanging frames on multiple links. Consequently, exchanging frames on multiple links according to the BA agreement may cause valid frames to be discarded, As such, wireless devices may experience limited efficiency and restricted performance.

### SUMMARY

Embodiments of a device, a method, and a system for Block Acknowledgement (Ack) (BA) operations are disclosed. In an embodiment, the device includes a wireless network interface device implemented on one or more integrated circuits (ICs), where the wireless network interface device is configured to negotiate a BA agreement for multiple links, where the BA agreement includes a managed scoreboard context and a managed reorder buffer, and exchange frames according to the BA agreement.

In an embodiment, the managed scoreboard context is flashed.

In an embodiment, the managed scoreboard context is flashed by deleting a scoreboard receiving window start (WinStart_{R}), a scoreboard receiving window size (WinSize_{R}), and a scoreboard receiving window bitmap.

In an embodiment, WinStart_{R} of the managed scoreboard context is updated based on a buffer window start (WinStart_{B}).

In an embodiment, WinStart_{R} of the managed scoreboard context is updated to WinStart_{B} when a difference between a buffer window end (WinEnd_{B}) and a largest sequence number of received frames from a first link is more than 2¹¹, and a temporary record of a scoreboard context of the first link exists.

In an embodiment, WinStart_{R} of the managed scoreboard context is updated to WinStart_{B} when a difference between WinStart_{R} of a first link and WinStart_{B} of the first link is more than 2¹¹, and a temporary record of a scoreboard context of the first link exists.

In an embodiment, WinStart_{R} of the managed scoreboard context of a first link is updated to WinStart_{R} of a second link.

In an embodiment, WinStart_{R} of the managed scoreboard context of a first link is updated to WinStart_{R} of a second link when a difference between WinStart_{R} of the first link and WinStart_{R} of the second link is more than 2¹¹, and WinStart_{R} of the second link has been updated.

In an embodiment, a temporary record of the managed scoreboard context for the BA agreement is deleted at an end of a transmission opportunity (TXOP).

In an embodiment, the managed scoreboard context is updated per a frame whose at least one of a decryption and an integrity check fails, and the updated managed scoreboard context rejects frames that pass at least one of the decryption and the integrity check.

In an embodiment, the managed scoreboard context is updated per a frame whose at least one of a decryption and an integrity check fails, and the managed scoreboard context resumes a state from before the update when the managed scoreboard context is updated per the frame whose at least one of the decryption and the integrity check fails.

In an embodiment, the managed scoreboard context is updated per a frame whose at least one of a decryption and an integrity check fails, and the decryption is before a BA scoreboard context.

In an embodiment, a reorder buffer of the managed scoreboard context is updated per a frame whose at least one of a decryption and an integrity check fails, and the decryption is before the reorder buffer.

In an embodiment, a reorder buffer of the managed scoreboard context is updated per a frame whose at least one of a decryption and an integrity check fails, and the reorder buffer resumes a state from before the update when the reorder buffer is updated per the frame whose at least one of the decryption and the integrity check fails.

In an embodiment, the reorder buffer is under a protected BA agreement.

In an embodiment, the BA agreement is negotiated between a first multi-link device (MLD) and a second MLD, and where when the second MLD has a separate scoreboard context for each of its links, the second MLD cannot use reorder buffer information of the managed scoreboard context to update the managed scoreboard context, and information of another link's scoreboard context to update the managed scoreboard context.

In an embodiment, the BA agreement is negotiated between a first MLD and a second MLD, and a station (STA) of the second MLD implements a partial-state operation for its scoreboard context when the second MLD has a separate scoreboard context for each of its links.

In an embodiment, the BA agreement is negotiated between a first MLD and a second MLD, and a recipient flushes the managed scoreboard context after sending a BA frame and after a TXOP.

A system for BA operations is also disclosed. In an embodiment, the system includes a first wireless device, where the first wireless device includes a wireless network interface device implemented on one or more integrated circuits (ICs), and where the wireless network interface device is configured to negotiate a BA agreement for multiple links, where the BA agreement includes a managed scoreboard context and a managed reorder buffer, transmit frames according to the BA agreement, a second wireless device, where the second wireless device includes another wireless network interface device implemented on one or more other ICs, and where the other wireless network interface device is configured to negotiate the BA agreement with the first wireless device, and receive the frames from the first wireless device according to the BA agreement.

A method for BA operations is also disclosed. In an embodiment., the method includes negotiating a BA agreement for multiple links, where the BA agreement includes a managed scoreboard context and a managed reorder buffer, and exchanging frames according to the BA agreement.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a multi-link communications system.

FIG. 2 depicts a High Throughput (HT)-immediate Block Acknowledgement (Ack) (BA) architecture.

FIG. 3 illustrates an overview flow of a Media Access Control (MAC) Service Data Unit (MSDU).

FIG. 4 depicts Directional Multi-Gigabit (DMG) BA architecture.

FIG. 5 is a table for an add BA (ADDBA) Response frame Action field format.

FIG. 6 illustrates communications between an initiator and a recipient.

FIG. 7 illustrates an overview flow diagram for generating an encrypted MAC protocol Data Unit (MPDU).

FIG. 8 illustrates an overview flow diagram for generating a plaintext MPDU.

FIG. 9 depicts an example of additional authentication data (AAD) construction for PV0 MPDUs.

FIG. 10 illustrates a flow diagram of a technique for BA operations in accordance with an embodiment of the invention.

FIG. 11 depicts an example of a computer that can implement technique for BA operations as described with reference to FIG. 10.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a multi-link communications system, a wireless device, e.g., an access point (AP) multi-link device (MLD) of a wireless local area network (WLAN) may exchange data with at least one associated non-access point (non-AP) MLD (e.g., a station (STA) MLD). In such an embodiment, the AP MUD may include one or more associated access points (APs) and the non-AP MLD may include one or more associated stations (STAs). The AP MLD may he configured to operate with associated non AP MLDs according to a communication protocol. For example, the communication protocol may be an Extremely High Throughput (EHT) communication protocol, or Institute of Electrical and Electronics Engineers (IEEE) 802.11 be communication protocol. Features of wireless communications and multi-link communications systems operating in accordance with the EHT communication protocol and/or next-generation communication protocols may be referred to herein as “non-legacy” features. In some embodiments of the multi-link communications system described herein, different associated STAs within range of an AP operating according to the EHT communication protocol are configured to operate according to at least one other communication protocol, which defines operation in a Basic Service Set (BSS) with the AP, but are generally affiliated with lower data throughput protocols. The lower data throughput communication protocols (e.g., High Efficiency (HE) communication protocol Very High throughput (VHT) communication protocol, etc.) may be collectively referred to herein as “legacy” communication protocols.

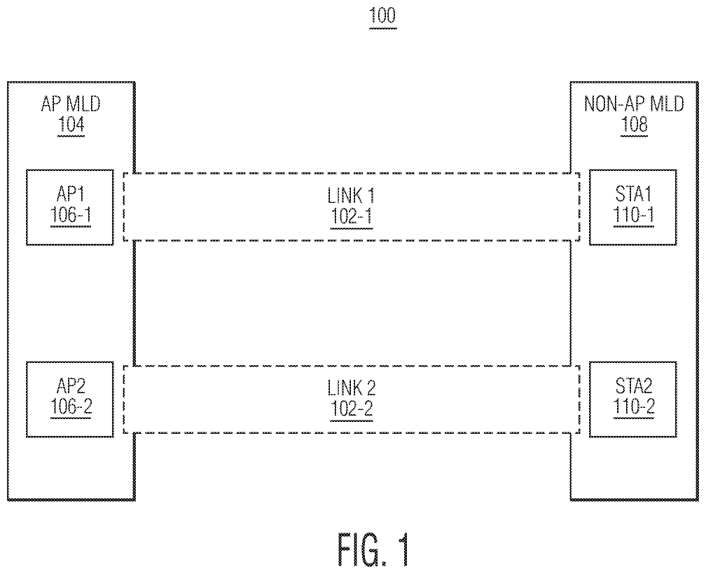

FIG. 1 depicts a multi-link communications system 100 that is used for wireless (e.g., Wi-Fi) communications, In the embodiment depicted in FIG. 1, the multi-link communications system includes one AP MLD, implemented as AP MLD 104, and one non-AP MLD (e.g., STA MLD), implemented as non-AP MLD 108. In an embodiment, the AP MLD 104 may be a first wireless device, and the non-AP MLD 108 may be a second wireless device. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with the IEEE 802.11be protocol. Although the depicted multi-link communications system 100 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD with multiple non-AP MLDs, or multiple AP MLDs with more than one non-AP MLD. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 104 includes two APs working on two radios, AP1 106-1 and AP2 106-2. In some embodiments, a common part of the AP MLD 104 implements upper layer Media Access Control (MAC) functionalities (e.g., Beacon creation, MLD association establishment, reordering of frames, etc.) and a link specific part of the AP MLD 104, i.e., the APs 106-1 and 106-2, implement lower layer MAC functionalities (e.g., backoff, frame transmission, frame reception, etc.). The APs 106-1 and 106-2 may be implemented in hardware (e.g., circuits), software, firmware, or a combination thereof. The APs 106-1 and 106-2 may be fully or partially implemented as an integrated circuit (IC) device, such that the APs include a wireless network interface implemented on one more ICs. In some embodiments, the APs 106-1 and 106-2 may be wireless APs compatible with at least one WLAN communications protocol (e.g., at least one IEEE 802.11 protocol). For example, the APs 106-1 and 106-2 may be wireless APs compatible with the IEEE 802.11be protocol.

In some embodiments, an AP MLD (e.g., AP MLD 104) connects to a local area network (e.g., a Local Area Network (LAN)) and/or to a backbone network (e.g., the Internet) through a wired connection and wirelessly connects to wireless STAs, for example, through one or more WLAN communications protocols, such as the IEEE 802.11 protocol. In some embodiments, an AP (e.g., AP1 106-1 and/or AP2 106-2) includes at least one antenna, at least one transceiver operably connected to the at least one antenna, and at least one controller operably connected to the corresponding transceiver. In some embodiments, the at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 106-1 or 106-2 of the AP MLD 104 may operate in a different BSS operating channel. For example, AP1 106-1 may operate in a 320 megahertz (MHz) BSS operating channel at 6 gigahertz (GHz) band and AP2 106-2 may operate in a 160 MHz BSS operating channel at 5 GHz band. Although the AP MLD 104 is shown in FIG. 1 as including two APs, other embodiments of the AP MLD 104 may include more than two APs or less than two APs.

In the embodiment depicted in FIG. 1, the non-AP MLD, implemented as non-AP MLD 108, includes two STAs (e.g., non-AP STAs), STA1 110-1 and STA2 110-2. The STAs 110-1 and 110-2 may be implemented in hardware (e.g., circuits), software, firmware, or a combination thereof. The STAs 110-1 and 110-2 may be fully or partially implemented as an IC device, such that the STAs include a wireless network interface device implemented on one or more ICs. In some embodiments, the STAs 110-1 and 110-2 are part of the non-AP MLD 108, such that the non-AP MLD may be a communications device that wirelessly connects to a wireless AP MLD. For example, the non-AP MLD 108 may be implemented in a laptop, a desktop personal computer (PC), a mobile phone, or other communications device that supports at least one WLAN communications protocol. In some embodiments, the non-AP MLD 108 is a communications device compatible with at least one IEEE 802.11 protocol (e.g., the IEEE 802.11be protocol). In some embodiments, the non-AP MLD 108 implements a common MAC data service interface and the STAs 110-1 and 110-2 implement a lower layer MAC data service interface. Although the non-AP MLD 108 is shown in FIG. 1 as including two STAs, other embodiments of the non-AP MLD 108 may include one STA or more than two STAs.

In some embodiments, the AP MLD 104 and/or the non-AP MLD 108 can identify which communication links support multi-link operation during a multi-link operation setup phase and/or exchanges information regarding multi-link capabilities during the multi-link operation setup phase. In some embodiments, each of the STAs 110-1 and 110-2 of the non-AP MLD 108 may operate in a different frequency band. For example, STA1 110-1 may operate in the 2.4 GHz frequency band and STA2 110-2 may operate in the 5 GHz frequency band. In some embodiments, each STA includes at least one antenna, at least one transceiver operably connected to the at least one antenna, and at least one controller connected to the corresponding transceiver. In some embodiments, the at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the non-AP MLD 108 communicates with the AP MLD 104 via two communication links, e.g., link 1 102-1 and link 2 102-2. For example, each of the STAs 110-1 or 110-2 communicates with AP1 106-1 or AP2 106-2 via corresponding communication links 102-1 or 102-2. In an embodiment, a communication link (e.g., link 1 102-1 or link 2 102-2) may include a BSS operating channel established by an AP (e.g., AP1 106-1 or AP2 106-2) that features multiple 20 MHz channels used to transmit frames in Physical Layer Convergence Procedure (PLCP) Protocol Data Units (PPDUs) (e.g., Date frames, Control frames, Management frames, Beacon frames, Action frames, etc.) between an AP MLD and a non-AP MLD. The PPDUs may be transmitted at signal bandwidths of, for example, 80 MHz, 160 MHz, or 320 MHz, and may include 20 MHz channels (sometimes referred to as “units”). In some embodiments, a 20 MHz channel may be a punctured 20 MHz channel (sometimes referred to as a “punctured channel” or a “punctured unit”) or an unpunctured 20 MHz channel (sometimes referred to as an “unpunctured channel” or an “unpunctured unit). Similar channels or units of a PPDU may be aggregated to form larger units (sometimes referred to as “segments”). For example, two unpunctured channels may be aggregated to form one unpunctured segment with a bandwidth of 40 MHz. Although the AP MLD 104 communicates (e.g., wirelessly communicates) with the non-AP MLD 108 via links 102-1 and 102-2, in other embodiments, the AP MLD 104 may communicate (e.g., wirelessly communicate) with the non-AP MLD 108 via more than two communication links or less than two communication links.

In some embodiments, an AP (e.g., AP1 106-1 or AP2 106-2) or an AP MLD (e.g., AP MLD 104) may perform Block Acknowledgement (Ack) (BA) operations with a non-AP STA (e.g., STA1 110-1 or STA2 110-2) or a non-AP STA MLD non-AP MLD 108). During the BA operations, an aggregated MAC Protocol Data Unit (A-MPDU) and a BA response frame can be transmitted in links between two MLDs (e.g., AP MLD 104 and non-AP MLD 108).

In an embodiment, when frames of the A-MPDU or the BA Request frames have a sequence number (SN) or starting sequence number (SSN) that is more than a scoreboard receiving window start (WinStart_{R}) plus 2¹¹ (WinStart_{R}+2¹¹) mod 4096 and less than WinStart_{R} may be discarded. Consequently, with multi-link operations, the frames and the BA Request frames who have an SN or an SSN that is more than WinStart_{R}+2¹¹ and less than WinStart_{R} may be valid frames. In some embodiments, group-addressed frames may be transmitted through multiple links and may have one SSN space. In such an embodiment, a non-AP MLD may switch its link for group-addressed frame reception after receiving (all) the group-addressed frames in a link. Consequently, link switch conditions may be relaxed, and duplicate detection rules may not be defined. As such, wireless devices may experience limited efficiency and restricted performance.

In accordance with an embodiment of the invention, a technique for BA operations is implemented by a device including a wireless network interface device implemented on one or more ICs, wherein the wireless network interface device is configured to negotiate a BA agreement for multiple links, wherein the BA agreement includes a managed scoreboard context and a managed reorder buffer, and exchange frames according to the BA agreement.

By exchanging frames according to the BA agreement that includes the managed scoreboard context and the managed reorder buffer, a non-AP MLD can switch its link for group-addressed frame reception at any time. Additionally, if a non-AP MLD uses multiple links to receive the group-addressed frames, then a duplication detection may not check a Retry subfield. As such, BA operations may be improved, which can result in increased efficiency and performance in wireless systems.

As described herein, a “BA agreement” may be negotiated by a first wireless device (e.g., a first MLD) and a second wireless device (e.g., a second MLD), such that “negotiated” may imply the first wireless device proposing parameters of the BA agreement to the second wireless device and the second wireless device accepting some (or all) of the parameters proposed by the first wireless device. In some embodiments, the “negotiation” may involve one or more frame exchanges to determine the “negotiated BA agreement”.

As described herein, a “managed scoreboard context” may be a scoreboard context included in a BA agreement (e.g., a negotiated BA agreement). A “managed scoreboard context” may correspond to one or more devices (e.g., an AP, an AP MLD, a non-AP STA, and/or a non-AP MLD), and may have been modified (e.g., updated, adjusted, flashed, etc.) by the one or more devices.

As described herein, a “managed reorder buffer” may be a reorder buffer included in a BA agreement (e.g., a negotiated BA agreement). A “managed reorder buffer” may correspond to one or more devices (e.g., an AP, an AP MILD, a non-AP STA, and/or a non-AP MLD), and may have been modified (e.g., updated, adjusted, flashed, etc.) by the one or more devices.

In some embodiments, a recipient (e.g., non-AP MLD 108) can implement a partial-state operation (e.g., a partial-state BA operation) or a full-state operation (e.g., a full-state operation). In the partial-state operation, when a scoreboard context cache does not appear, the full-state operation applies. Otherwise, WinStart_{R} and a scoreboard receiving window end (WinEnd_{R}) may be established per a received BA Request frame or per frames included in an A-MPDU.

When an SN of a frame in a received A-MPDU is more than WinStart_{R}+2¹¹ and less than WinStart_{R}, the scoreboard context may not change, such that the operation of mod 4096 may be required (although may not be shown). When an SSN of a received BA Request frame is more than WinStart_{R}+2¹¹ and less than WinStart_{R}, the BA Request frame is discarded. When the SN of a frame in a received A-MPDU is more than a buffer window start (WinStart_{B}) plus 2¹¹ (WinStart_{B}+2¹¹) and less than WinStart_{B}, the frame is discarded.

In some embodiments, a recipient (e.g., non-AP MLD 108) sends a responding BA frame after adjusting WinStart_{R} and WinStart_{B}. In such an embodiments, a bit in a BA bitmap whose SN is more than WinEnd_{R} is set to zero, and a bit in a BA bitmap whose SN is less than WinStart_{R} can be set to zero or one.

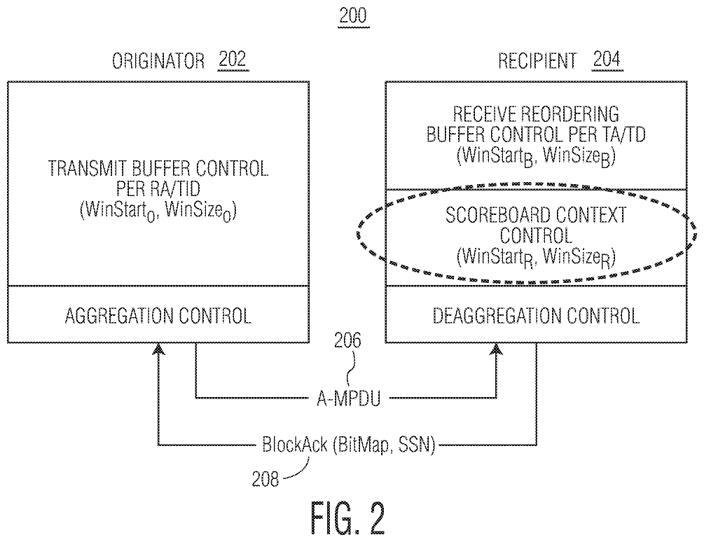

An example of a High Throughput (HT)-immediate BA architecture is described in further detail with reference to FIG. 2

FIG. 2 depicts an HT-immediate BA architecture 200. In the embodiment of FIG. 2, the HT-immediate BA architecture 200 includes an originator 202 and a recipient 204. The originator 202 may be an AP (e.g., AP1 106-1), an AP MLD (e.g., AP MLD 104), a non-AP STA (e.g., STA1 110-1), or a non-AP STA MLD (e.g., non-AP MLD 108). The recipient 204 may be an AP, an AP MLD, a non-AP STA, or a non-AP STA MLD. In some embodiments, when the recipient 204 is an AP MLD or a non-AP STA MLD, each link may have its own scoreboard context (not shown), and a single reorder buffer will be at MLD level.

In some embodiments, the originator 202 and the recipient 204 may communicate via one or more communication links (e.g., link1 102-1 and/or link2 102-2). The originator 202 and the recipient 204 may communicate to negotiate a BA agreement for multiple links. For example, the originator 202 may generate, then transmit an A-MPDU 206 to the recipient 204, and the recipient 204 may generate, then transmit a BA frame 208 to the originator 202. In such an example, the BA frame includes a bitmap and a starting sequence number (SSN).

In an embodiment, the originator 202 generates a transmit buffer control per BA agreement identified by recipient MLD address named as RA (BA agreement between MLDs) or a recipient MAC address named as RA (BA agreement not between MLDs), or per a Traffic Identifier (TID) of the A-MPDU 206. The transmit buffer control per RA/TID includes an originator window start (WinStart_{O}) and an originator window size (WinSize_{O}). The originator 202 may also generate an aggregation control of the A-MPDU 206.

In an embodiment, the recipient 204 generates a receive reordering buffer control per BA agreement identified by Transmitter Address (TA), i.e., an initiator MLD address for the BA agreement between two MLDs or an initiator MAC address for a BA agreement not between two MLDs, and a TID of a received A-MPDU. The receive reordering buffer control per TA/TID includes WinStart_{B} and a buffer window size (WinSize_{B}). In an embodiment, the recipient 204 generates a scoreboard context control of the BA frame, such that the scoreboard context control includes WinStart_{R} and a scoreboard receiving window size (WinSize_{R}). In some embodiments, the scoreboard context control may be a managed scoreboard context. In an embodiment, the recipient 204 generates a deaggregation control of the BA frame 208.

In some embodiments, an MLD (e.g., non-AP MLD 108) may maintain an independent scoreboard context in each of its links. For example, non-AP MLD 108 may have a first scoreboard context (e.g., scoreboard context 1) that corresponds to link1 102-1 and STA1 110-1, and a second scoreboard context (e.g., scoreboard context 2) that corresponds to link2 102-2 and STA2 110-2. In some embodiments, non-AP MLD 108 may use link1 102-1 and link2 102-2 to transmit frames of the same BA agreement, i.e., a frame from a single TID can be transmitted in multiple links (e.g., link1 102-1 and/or 1ink2 102-2).

Consequently, there may several issues associated with maintaining an independent scoreboard context in each link. Originally, STA1 110-1 and STA2 110-2 have a same WinStart_{R} for a first TID (TID1) (e.g., WinStart_{R1}). When an AP MLD (e.g., AP MLD 104) uses link2 102-2 to transmit an A-MPDU with Quality of Service (QoS) Data frames of TID1 to non-AP MLD 108, WinStart_{R} of STA2 110-2 becomes WinStart_{R1}+2¹¹+200. When AP MLD 104 switches its link to transmit A-MPDU with QoS frames of TID1 whose SNs are WinStart_{R1}+2¹¹+200 mod 4096 to WinStart_{R1}+2¹¹+200+63 mod 4096to non-AP MLD 108, STA1 110-1 may now acknowledge frames of the A-MPDU (although reorder buffer will accept frames within the A-MPDU). Additionally, when AP MLD 104 uses link1 102-1 and link2 102-2 to transmit frames with a same TID and a recipient transmits a BA frame in one link (e.g., link1 102-1) that includes a received frame of another link (e.g., link2 102-2), BE creation rules may be incorrect because an SN that is larger than WinEnd_{R} may be correctly accepted in link2 102-2, and an SN that is smaller than WinStart_{R} may be correctly accepted in link2 102-2.

In one embodiment, for a full-state scoreboard context, when a difference between a buffer window end (WinEnd_{B}) (updated per a second link's frames) and a largest SN of received frames from a first link is more than 2¹¹, WinStart_{R} is updated to WinStart_{B} or WinEnd_{B}. In another embodiment, when the difference of WinStart_{R} of a first link and WinStart_{B} of the first link (updated per the second link's frames) is more than 2¹¹, the WinStart_{R} of the first link is updated to WinStart_{B}. Such an embodiment may be applied to the first link when WinStart_{B} is updated per received frames from another link (e.g., the second link), when the first links switches from a disabled link to an enabled link, when the first link switches to an awake state in a power save mode, and/or when the first link switches to an active mode from the power save mode.

In another embodiment, for a full-state scoreboard context, when a difference between WinStart_{R} of a first link and WinStart_{R} of a second link is more than 2¹¹ and WinStart_{R} of the second link is newly updated, then WinStart_{R} of the first link is updated to WinStart_{R} of the second link. Such an embodiment may be applied to the first link when WinStart_{R} is updated per received frames from another link (e.g., the second link), when the first links switches from a disabled link to an enabled link, when the first link switches to an awake state in a power save mode, and/or when the first link switches to an active mode from the power save mode. In another embodiment, an SN of a frame is used to set the scoreboard context if a frame is not discarded in a reorder buffer because the SN is less than WinStart_{B} and more than WinStart_{B}2¹¹, or if the SN of the frame is less than WinStart_{R} and more than WinStart_{R}+2¹¹.

In some embodiments, for a partial state scoreboard context, a managed scoreboard context is flashed. In such an embodiment, the managed scoreboard context is flashed by deleting WinStart_{R}, a scoreboard receiving window size (WinSize_{R}), and a scoreboard receiving window bitmap. In some embodiments, for the partial-state scoreboard context, a temporary record of the managed scoreboard context for a BA agreement is deleted at an end of a transmission opportunity (TXOP). In some embodiments, for the partial-state scoreboard context, a temporary record of the managed scoreboard context for a BA agreement created by one TXOP is deleted at a following transmission TXOP before processing the received A-MPDU if the received A-MPDU is related to the BA agreement.

In some embodiments, for a partial-state scoreboard context, WinStart_{R} of a managed scoreboard context is updated based on WinStart_{B}. As an example, WinStartR of the managed scoreboard context is updated to WinStart_{B} when a difference between WinEnd_{B} and a largest sequence number of received frames from a first link is more than 2¹¹, and a temporary record of a scoreboard context of the first link exists. As another example, WinStart_{R} of the managed scoreboard context is updated to WinStart_{B} when a difference between WinStart_{R} of a first link and WinStart_{B} of the first link is more than 2¹¹, and a temporary record of a scoreboard context of the first link exists.

In some embodiments, for a partial-state scoreboard context, WinStart_{R} of a managed scoreboard context of a first link is updated to WinStart_{R} of a second link. As an example, WinStart_{R} of the managed scoreboard context of a first link is updated to WinStart_{R} of a second link when a difference between WinStart_{R} of the first link and WinStart_{R} of the second link is more than 2¹¹, and WinStart_{R} of the second link has been updated.

In some embodiments, when an AP MLD (e.g., AP MLD 104) uses both its links (e.g., link1 102-1 and link2 102-2) to transmit frames with a same TID and a recipient (e.g., non-AP MLD 108) transmits a BA frame in link1 102-1 that includes a received frame of link2 102-2, BA creation for frames that are larger than WinEnd_{R} of less than WinStart_{R} are as described herein. For the BA creation, a larger value of WinEnd_{R} of the second link and WinEnd_{R} of the first link is treated as WinEnd_{R} (updated WinEnd_{R}). Alternatively, for the BA creation, the smaller value of WinStart_{R} of the second link WinStart_{R} of the first link treated as WinStart_{R} (updated WinStart_{R}), unless the difference of the updated WinEnd_{R} and the updated WinStart_{R} (updated WinEnd_{R}—updated WinStart_{R}+1) is more than a negotiated BA bitmap size of BA, in which case the updated WinStart_{R} has the value where the value and the updated WinEnd_{R} create the negotiated BA bitmap size.

The negotiated BA bitmap size may be defined as described herein. If a negotiated BA buffer size is no more than 64, then the negotiated BA bitmap size is 64. If the negotiated BA buffer size is more than 64 and no more than 256, then the negotiated BA bitmap size is 256. If the negotiated BA buffer size is more than 256 and no more than 512, then the negotiated BA bitmap size is 512. If the negotiated BA buffer size is more than 512 and no more than 1024, then the negotiated BA bitmap size is 1024.

In some embodiments, a managed scoreboard context is updated per a frame whose decryption or integrity check fails. In such an embodiment, the updated managed scoreboard context can reject frames that pass the decryption or the integrity check. In one embodiment, the managed scoreboard context resumes a state from before the update when the managed scoreboard context is updated per the frame whose decryption or integrity check fails. In another embodiment, the decryption is before a BA scoreboard context when the managed scoreboard context is updated per a frame whose at least one of a decryption and an integrity check fails. Such embodiments may only be applied to a protected BA agreement.

In some embodiments, a reorder buffer of a managed scoreboard context is updated per a frame whose decryption or integrity check fails. In one embodiment, the decryption is before the reorder buffer when the reorder buffer of the managed scoreboard context is updated per the frame whose decryption or integrity check fails. Such an embodiment may only be applied to a protected BA agreement. In another embodiment, the reorder buffer resumes a state from before the update when the reorder buffer is updated per the frame whose at least one of the decryption and the integrity check fails. In some embodiments, the reorder buffer is under a protected BA agreement.

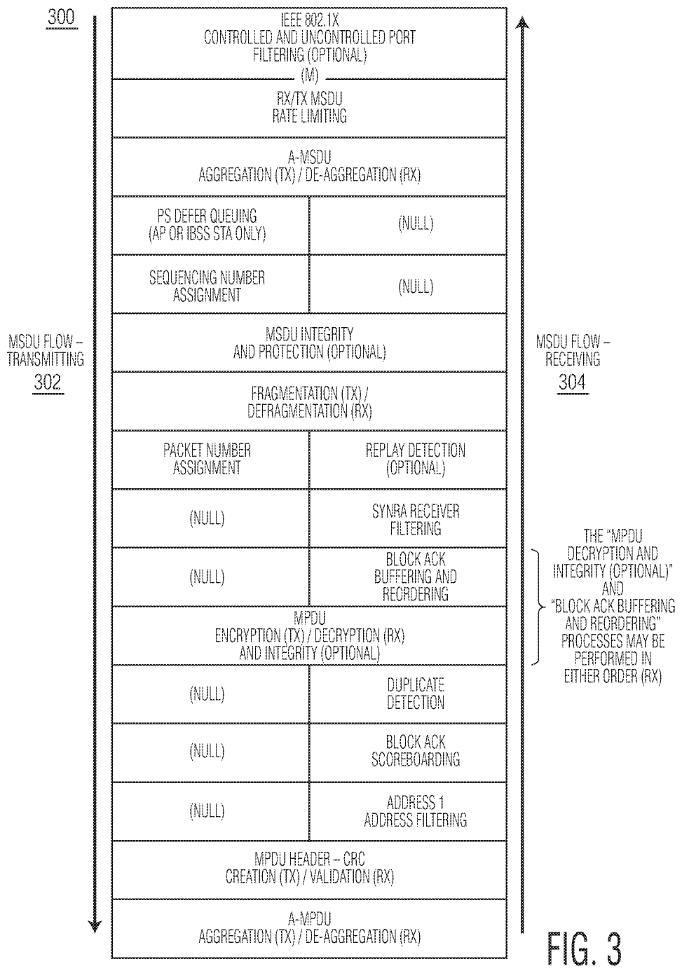

An example of an MAC Service Data Unit (MSDU) is described in further detail with reference to FIG. 3.

FIG. 3 illustrates an overview flow 300 of a MSDU. As shown, the overview flow 300 of the MSDU includes a transmitting MSDU flow 302 and a receiving MSDU flow 304. The transmitting MSDU flow 302 may be used by a wireless device when transmitting an MSDU, and the receiving MSDU flow 304 may be used by the wireless device when receiving an MSDU. In some embodiments, for MSDUs or aggregated-MSDUs (A-MSDUs) transmitted using a BA feature, reordering of received MSDUs or A-MSDUs according to the BA receiver option may be performed prior to replay detection.

In some embodiments, an initiator (e.g., AP MLD 104) initiates negotiation of a BA agreement with a BA agreement recipient (e.g., non-AP MLD 108). Once a BA buffer size is negotiated, the buffer size may not be changed unless in a 60 GHz band, where the recipient of an add BA (ADDBA) Request frame can announce a new buffer limit. In an embodiment, there may be a requirement that a recipient uses a management frame to update its BA buffer. As such, an unsolicited ADDBA Response frame allows the BA agreement recipient to update the BA buffer size.

In some embodiments, an originator (e.g., AP MLD 104) and a recipient (e.g., non-AP MLD 108) can negotiate a BA agreement by exchanging an ADDBA Request frame and an ADDBA Response frame. The recipient can implement a partial-state operation or a full-state operation. In the partial-state operation, when a scoreboard context in cache does not disappear, the full-state operation applies. Otherwise, WinStart_{R} and WinEnd_{R} may be established per a received BA Request frame or frames in an A-MPDU.

In an embodiment, when an SN of a frame in received A-MPDU is more than WinStart_{R}+2¹¹ and less than WinStart_{R}, a scoreboard context does not change (operation of mod 4096 may be required although not shown). In another embodiment, when an SSN of a received BA Request frame is more than WinStart_{R}+2¹¹ and less than WinStart_{R}, the BA Request frame is discarded. In yet another embodiment, when the SN of a frame in a received A-MPDU is more than WinStart_{B}+2¹¹ and less than WinStart_{B}, the frame is discarded.

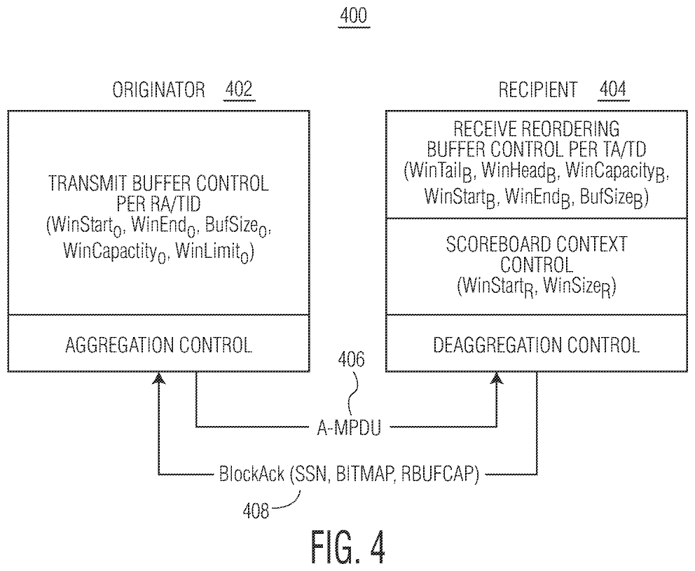

In some embodiments, a recipient sends a BA Request frame after adjusting WinStart_{R} and WinEnd_{R}. In such an embodiment, a bit in a BA bitmap whose SN is more than WinEnd_{R} is set to zero, and a bit in the BA bitmap is less than WinStart_{R} can be set to zero or one. Additionally, for Directional Multi-Gigabit (DMG) (60 GHz band), the recipient is allowed to perform flow control by announcing a receiver buffer capacity (RBUFCAP). An example of DMG BA architecture is described in further detail with reference to FIG. 4.

FIG. 4 depicts DMG BA architecture 400. In the embodiment of FIG. 4, the DMG BA architecture 400 includes an originator 402 that generates an A-MPDU 406, and a recipient 404 that generates a BA frame 408 as described with reference to FIG. 2.

In contrast to FIG. 2, the BA frame 408 of the DMG BA architecture 400 includes a bitmap, an SSN, and a RBUFCAP field. The transmit buffer control per RA/TID controlled by the originator 402 includes WinStart_{O}, an originator window end (WinEnd_{O}), an originator buffer window size (BufSize_{O}), an originator window capacity (WinCapacity_{O}), and an originator window limit (WinLimit_{O}). In addition, the receive reordering buffer control per TA/TID controlled by the recipient 404 includes a buffer window tail (WinTail_{B}), a buffer window head (WinHead_{B}), a buffer window capacity (WinCapacity_{B}), WinStart_{B}, WinEnd_{B}, and a buffer size (BufSize_{B}).

In bands other than a 60 GHz band, after a BA agreement has been negotiated and established, a negotiated buffer may not be changed. Although the 60 GHz band allows the recipient to perform follow control for rapid buffer size adaptation, processing of an additional control frame may be required. Additionally, when something occurs (e.g., a systematic change) at a recipient, a negotiated BA buffer size may be difficult to support. For example, when an AP acts as a recipient and negotiates too many BA agreements, such that a rapid buffer size adaptation may not be needed.

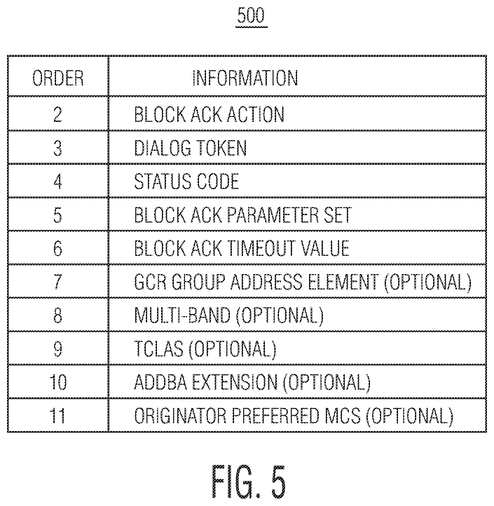

As such, after a BA agreement has been negotiated (and established) for a TID between an initiator (e.g., AP MLD 104) and a recipient (e.g., non-AP MLD 108), the recipient can update a buffer size by sending an unsolicited ADDBA Response frame. In one embodiment, a value in a Buffer Size field of the unsolicited ADDBA Response frame may not be more than a negotiated buffer size, and other parameters of the negotiated BA agreement may not be changed. In another embodiment, a buffer size in the unsolicited ADDBA Response frame may be more than the negotiated buffer size, and the other parameters of the negotiated BA agreement can be changed. A table that defines an ADDBA Response frame Action field format is described in further detail with reference to FIG. 5

FIG. 5 is a table 500 for an ADDBA Response frame Action field format. In an embodiment, the table 500 for the ADDBA Response frame Action field format includes two columns, implemented as first column (shown by “Order”) and a second column (shown by “Information”). As shown, the information is defined according to the orders from 2-11.

In some embodiments, when transmitting a PPDU, each 20 MHz channel has a same Power Spectral Density (PSD), such that a PPDU with a wider bandwidth can reach an STA that is further away than would a PPDU with a narrow bandwidth. In such an embodiment, an AP may disallow narrow bandwidth transmissions in its BSS. As an example, in an 80 MHz BSS, a 20 MHz/40 MHz (non-HT duplicate) PPDU is disallowed. As another example, in a 160 MHz BSS, a 20 MHz/40 MHz (non-HT duplicate) PPDU is disallowed or a 20/40/80 MHz (non-HT duplicate) PPDU is disallowed. Besides detecting a PPDU from a primary 20 MHz channel for Clear Channel Assessment (CCA) or a Network Allocation Vector (NAV) setting, PPDU detection in a greater than 20 MHz bandwidth is applied. For example, an 80 MHz STA will try to detect a PPDU in a primary 20 MHz channel and an 80 MHz channel. In such an example, part of the PPDU is combined in four 20 MHz channels, and if a PHY header is detected correctly in the 80 MHz channel, then the STA combines the non-HT duplicate PPDU in 80 MHz or decodes an 80 MHz HE/EHT PPDU. As such, collision can be avoided because the STA may be far away from the AP in the BSS, and can detect a TXOP of the BSS.

In some embodiments, an EHT STA transmits a Probe Request with limit information as defined by IEEE 802.11be D1.1 to decrease the overhead. Accordingly, the EHT STA may miss some non-EHT APs since those non-EHT APs may not respond with Probe Response frames after receiving the Probe Request. In one embodiment, if the EHT STA (only) wants to find EHT APs to associate with, then the EHT STA transmits a Probe Request with limit information. In another embodiment, if the EHT STA wants to find either non-EHT APs or EHT APs to associate with, then the EHT STA transmits a Probe Request with full information as defined by IEEE 802.11 baseline. In yet another embodiment, the EHT STA transmits a Probe Request with full information as defined by the IEEE 802.11 baseline to find candidate APs for association.

In some embodiments, under protected BA (PBA) operations, a recipient may update its WinStart_{R} when a BA Request frame is received. Consequently, BA Request frames from a third-party STA may let the recipient update its WinStart_{R} so that following received frames may not be used to update a scoreboard context. Accordingly, a BA may not be created correctly because an SN of the received frame is less than WinStart_{R} and more than WinStart_{R}+2048. To address the issue, a recipient may not update WinStart_{R} when it received a BA Request frame, but a BA frame may be transmitted after receiving the BA Request frame. If an initiator receives a BA frame that is not solicited by its frame(s), then the initiator may not update its transmit buffer per the received BA.

In some embodiments, a scoreboard context may be updated per frames from a third-party STA whose decryption fails. In such an embodiment, if after a recipient updates its reordering buffer per a received frame and WinStart_{R} is more than WinStart_{B}, then WinStart_{R} is updated to a same value as WinStart_{B}. If the recipient cannot update WinStart_{R} to the same value as WinStart_{B}, then the recipient may perform a partial-state operation. In an embodiment, the recipient may need to flush the scoreboard context after sending a BA and/or flush the scoreboard context after each TXOP.

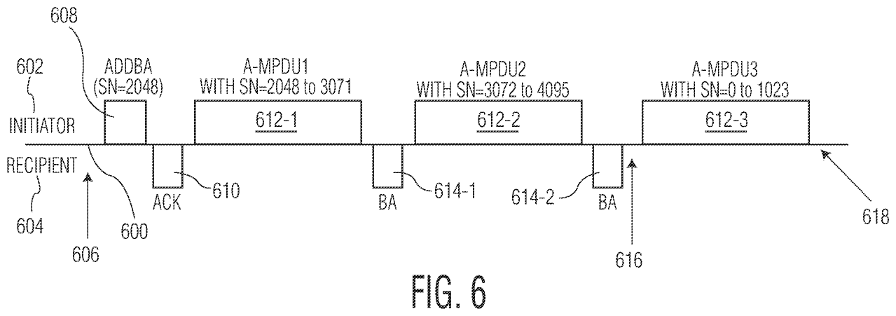

In some embodiments, an encrypted ADDBA Request frame used to update WinStart_{R} and WinStart_{B} may create an incorrect frame discarding because it is difficult to predict processing time of ADDBA. As such QoS Data frames in an A-MPDU may also update WinStart_{R} and WinStart_{B} if their SNs are greater than WinStart_{R} and WinStart_{B}, respectively (and less than WinStart_{R}+2048 and WinStart_{B}+2048, respectively). An example of communications where an initiator and a recipient exchange an ADDBA frame and A-MPDUs is described in further detail with reference to FIG. 6.

FIG. 6 illustrates communications between an initiator 602 and a recipient 604. The initiator 602 may be an AP (e.g., AP1 106-1), an AP MLD (e.g., AP MLD 104), a non-AP STA (e.g., STA1 110-1), or a non-AP STA MLD (e.g., non-AP MLD 108). The recipient 604 may be an AP, an AP MLD, a non-AP STA, or a non-AP STA MLD. The initiator 602 and the recipient 604 may communicate via link 600.

In an embodiment, at a first time (shown by arrow 606) before exchanging frames, WinStart_{R} equals WinStart_{B}, which equals 1023. The frame exchange begins when initiator 602 transmits an ADDBA frame 608 with an SN of 2048 to the recipient 604. After receiving the ADDBA frame 608, the recipient transmits an Ack frame 610 to the initiator 602.

The initiator 602 then transmits a first A-MPDU (A-MPDU1) 612-1 to the recipient 604. In an embodiment, A-MPDU1 612-1 has an SN equal to 2048 to 3061. In response to receiving A-MPDU1 612-1, the recipient 604 transmits a first BA frame 614-1 to the initiator 602. The initiator 602 then transmits a second A-MPDU (A-MPDU2) 612-2 to the recipient 604. In an embodiment, A-MPDU2 612-2 has an SN equal to 3072 to 4095. In response to receiving A-MPDU2 612-2, the recipient 604 transmits a second BA frame 614-2 to the initiator 602.

At a second time (shown by arrow 616), WinStart_{R} equals WinStart_{B}, which equals 2048. The initiator 602 then transmits a third A-MPDU (A-MPDU3) 612-3 to the recipient 604. In an embodiment, A-MPDU3 612-3 has an SN equal to 0 to 1023. At a third time (shown by arrow 618), frames in an A-MPDU are discarded.

In some embodiments, an ADDBA frame may not be used to update WinStart_{R} and WinStart_{B}. In some embodiments, a recipient announces a Defer Time where if an originator transmits the ADDBA frame to adjust WinStart_{R}/WinStart_{B} of a BA agreement, then a following A-MPDU of the BA agreement may not be transmitted within the Defer Time starting at an end time of the ADDBA frame. In such an embodiment, the Defer Time may also be a unified time rather than a value announced by each recipient. In some embodiments, within a TXOP where an ADDBA frame is transmitted for a BA agreement, an A-MPDU of the same BA agreement may not be transmitted.

In some embodiments, if a recipient MLD has a separate scoreboard context in each link and the recipient may not use the information of reorder buffer to update the information of scoreboard context or use the information of another link's scoreboard context, then the STA of each link may need to implement a partial-state operation for its scoreboard context. In such an embodiment, the recipient may need to flush the scoreboard context after it sends a BA.

In some embodiments, if a recipient MLD has separate scoreboard context in each link and the recipient can use the information of reorder buffer to update the information of scoreboard context, then the STA of each link can implement either partial-state operation or full-state operation for its scoreboard context. In such an embodiment, an STA affiliated with the recipient MLD may need to receive a frame with an SN that satisfies WinStart_{B}+2¹¹≤SN<WinStart_{R}, where the SN of the frame does not satisfy WinStart_{B}+2¹¹≤SN<WinStart_{B}. In an embodiment, the STA may update the scoreboard context as if the frame with the SN that satisfies WinEnd_{R}≤SN<WinStart_{R}+2¹¹ is received.

In some embodiments, when a BA agreement is negotiated between a first MLD and a second MLD, and when the second MLD has a separate scoreboard context for each of its links, the second MLD cannot use reorder buffer information of the managed scoreboard context to update the managed scoreboard context, and information of another link's scoreboard context to update the managed scoreboard context. In some embodiments, when a BA agreement is negotiated between a first MLD and a second MLD, a STA of the second MLD implements a partial-state operation for its scoreboard context when the second MLD has a separate scoreboard context for each of its links. In some embodiments, when a BA agreement is negotiated between a first MLD and a second MLD, a recipient flushes the managed scoreboard context after sending a BA frame and after a TXOP.

In some embodiments, a third -party STA may capture a QoS Data frame transmitted by a BA agreement initiator to a BA agreement recipient, and transmits the captured frame with a different SN. In such an embodiment, the recipient may update a reorder buffer and discard the frame during replay detect. As such, an SN subfield in a Single Carrier (SC) field of additional authentication data (AAD) may be the SN subfield in a frame header of an encrypted QoS Data frame or a decrypted QoS Data frame. Alternatively, a pseudorandom number (PN) field may carry a value of the SN subfield of the encrypted QoS Data frame or the decrypted QoS Data frame. As an example, for each encrypted QoS Data frame related to a PN space, a value of a new PN is increase by 2¹² and a PN[0 to 11] is a value of the SN subfield of the encrypted QoS Data frame or the decrypted QoS Data frame.

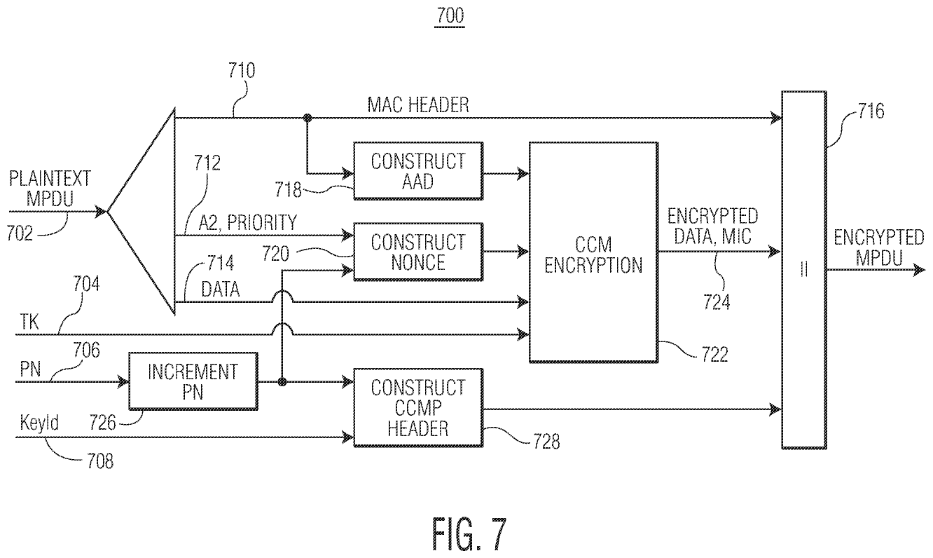

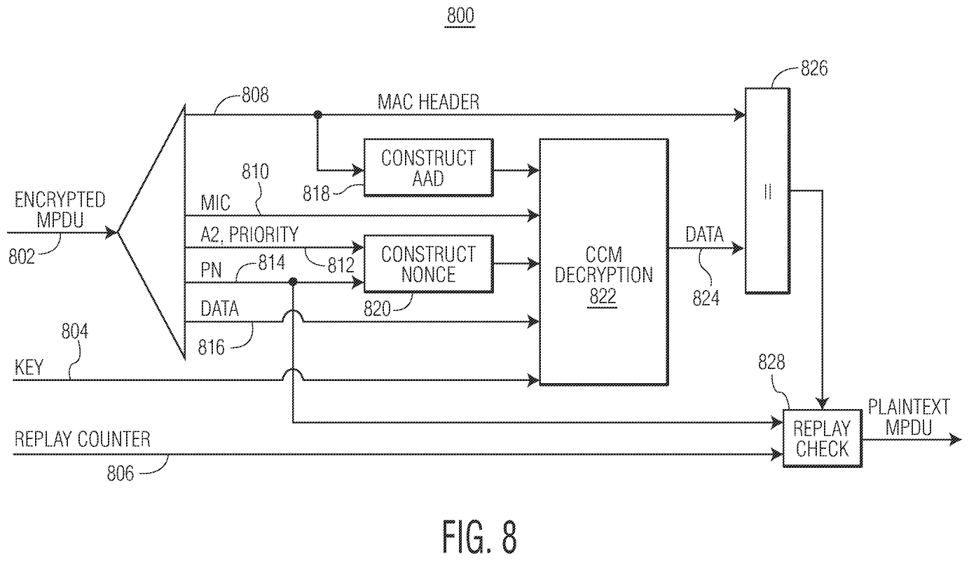

Examples of flow diagrams for generating an encrypted MPDU and a plaintext MPDU are described in further detail with reference to FIG. 7 and FIG. 8, respectively.

FIG. 7 illustrates an overview flow diagram 700 for generating an encrypted MAC protocol Data Unit (MPDU). To generate the encrypted MPDU, a plaintext MPDU 702, a Temporal Key (TK) 704, a PN 706, and a Key Identifier (KeyId) 708 are generated.

The plaintext MPDU 702 is split into a MAC header 710, A2 Priority 712, and data 714. The MAC header 710 is forwarded to an encrypted MPDU generation step 716 and/or a construct AAD step 718. The A2 Priority 712 is forwarded to a construct nonce step 720. The data 714, data from the construct AAD step 718, and data from the construct nonce step 720 is forwarded to a Counter with Cipher Block Chaining—Message Authentication Code (CCM) encryption step 722.

TK 704 is forwarded to the CCM encryption step 722. From the CCM encryption step 722, encrypted data and a message integrity check (MIC) are forwarded to the encrypted MPDU generation step 716. The PN 706 is forwarded to an increment PN step 726, which is forwarded to the construct, nonce encoding step 720 and/or a construct CCM mode Protocol (CCMP) header step 728. The KeyID 708 is forwarded to the construct CCMP header step 728, which is forwarded to the encrypted MPDU generation step 716. The encrypted MPDU is produced from the encrypted MPDU generation step 716.

FIG. 8 illustrates an overview flow diagram 800 for generating a plaintext MPDU. To generate the plaintext MPDU, an encrypted MPDU 802, a Key 804, and a replay counter 806 are generated. In some embodiments, the encrypted MPDU 802 is an encrypted MPDU generated from the overview flow diagram 700 (FIG. 7).

The encrypted MPDU 802 is split into a MAC header 808, MIC 810, A2 Priority 812, PN 814, and data 816. The MAC header 808 is forwarded to a plaintext MPDU generation step 826 and/or a construct AAD step 818. The A2 Priority 812 is forwarded to a construct nonce step 820. The PN 814 is forwarded to the construct nonce step 820 and/or a replay check step 828. The MIC 810, the data 816, data from the construct AAD step 818, and data from the construct nonce step 820 is forwarded to a CCM decryption step 822.

The Key 804 is forwarded to the CCM decryption step 822. From the CCM decryption step 822, data 824 is forwarded to the plaintext MPDU generation step 826. Data from the plaintext MPDU generation step 826 is forwarded to the replay check step 828. The replay counter 806 is forwarded to the replay check step 828. The plaintext MPDU is generated from the replay check step 828.

In some embodiments, a PN is checked when a received MPDU is put in a reordering buffer. If an MPDU with a PN value that is the same as a received MPDU exists in the reordering buffer, then the received MPDU is discarded. Additionally, for MSDUs or A-MSDUs transmitted using a BA feature, replay detection may be performed after the reordering buffer.

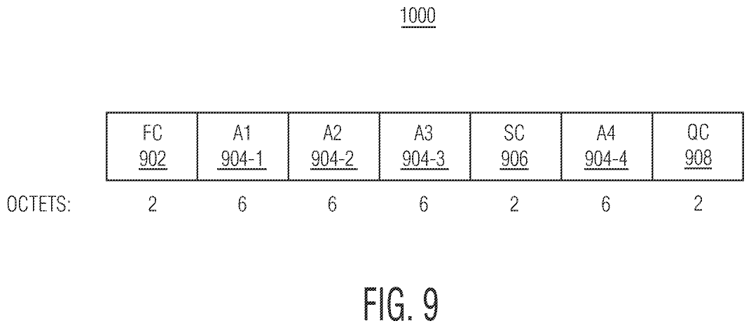

An examples of AAD construction for PV0 MPDUs is described in further detail with reference to FIG. 9.

FIG. 9 depicts an example of AAD construction for PV0 MPDUs 900. In an embodiment, the AAD construction for PV0 MPDUs 900 includes seven fields, implemented as a Frame Control (FC) field 902 (2 octets), a first aggregated (A1) field 904-1 (6 octets), a second aggregated (A2) field 904-2 (6 octets), a third aggregated (A3) field 904-3 (6 octets), an SC field 906 (2 octets), a fourth aggregated (A4) field 904-4 (6 octets), and a Quality Control (QC) field 908 (2 octets).

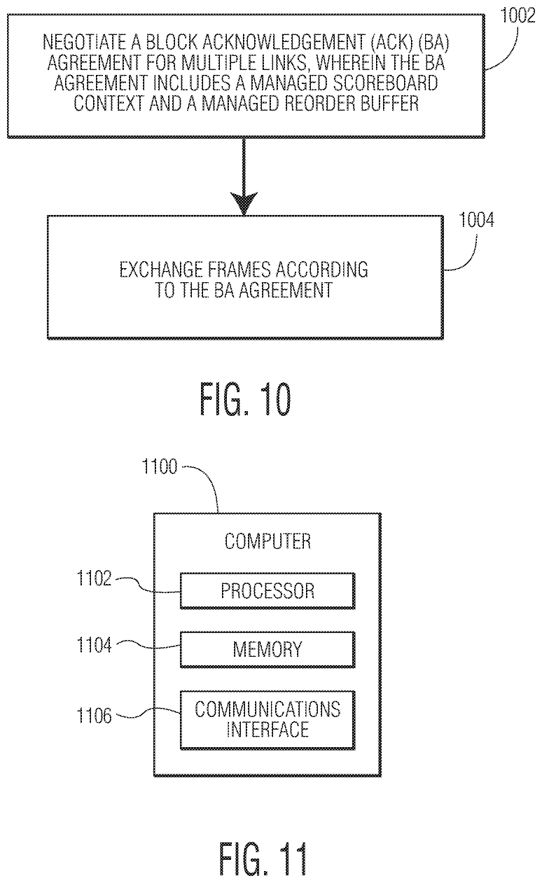

FIG. 10 illustrates a flow diagram of a technique for BA operations in accordance with an embodiment of the invention. At block 1002, a device negotiates a BA agreement for multiple links, where the BA agreement includes a managed scoreboard context and a managed reorder buffer. At block 1004, the device exchanges frames according to the BA agreement.

In some embodiments, the technique for BA operations may be implemented by a system. For example, a system includes a first wireless device, where the first wireless device includes a wireless network interface device implemented on one or more ICs, where the wireless network interface device is configured to negotiate a BA agreement for multiple links, where the BA agreement includes a managed scoreboard context and a managed reorder buffer, and transmit frames according to the BA agreement. In such an example, the system also includes a second wireless device, where the second wireless device includes another wireless network interface device implemented on one or more other ICs, where the other wireless network interface device is configured to negotiate the BA agreement with the first wireless device, and receive the frames from the first wireless device according to the BA agreement.

In some embodiments, the technique for BA operations includes negotiating a BA agreement for multiple links, where the BA agreement includes a managed scoreboard context and a managed reorder buffer, and exchanging frames according to the BA agreement.

In an embodiment, the above-described functionality is performed at least in part by a computer or computers, which executes computer readable instructions. FIG. 11 depicts an example of a computer 1100 that can implement the technique for BA operations as described herein with reference to FIG. 10. As shown, the computer 1100 includes a processor 1102, a memory 1104, and a communications interface 1106. The processor may include a multifunction processor and/or an application-specific processor. As an example, the processor could be a CPU (with software), an application-specific integrated circuit (AMC), a transceiver, a radio, or a combination thereof. The memory within the computer may include, for example, storage medium such as read only memory (ROM), flash memory, random-access memory (RAM), and a large capacity permanent storage device such as a hard disk drive. The communications interface enables communications with other computers via, for example, the Internet Protocol (IP). The computer executes computer readable instructions stored in the storage medium to implement various tasks as described above.

As an example, the computer 1100 may represent a wireless device (e.g., an AP, an AP MLD, a non-AP STA, or a non-AP STA MLD). In such an example, the wireless device includes a wireless network interface device implemented on one or more ICs. As an example, the wireless network interface device may include or connect to antennas, processors, batteries, storage mediums, etc., and may be configured to perform wireless operations and/or communications.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, an RAM, an ROM, a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc. Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A device comprising:
a wireless network interface device implemented on one or more integrated circuits (ICs), wherein the wireless network interface device is configured to:
negotiate a Block Acknowledgement (Ack) (BA) agreement for multiple links, wherein the BA agreement includes a managed scoreboard context and a managed reorder buffer; and
exchange frames according to the BA agreement.

2. The device of claim 1, wherein the managed scoreboard context is flashed.

3. The device of claim 2, wherein the managed scoreboard context is flashed by deleting a scoreboard receiving window start (WinStart_{R}), a scoreboard receiving window size (WinSize_{R}), and a scoreboard receiving window bitmap.

4. The device of claim 1, wherein WinStart_{R} of the managed scoreboard context is updated based on a buffer window start (WinStart_{B}).

5. The device of claim 1, wherein WinStart_{R} of the managed scoreboard context is updated to WinStart_{B} when:
a difference between a buffer window end (WinEnd_{B}) and a largest sequence number of received frames from a first link is more than 2¹¹; and
a temporary record of a scoreboard context of the first link exists.

6. The device of claim 1, wherein WinStart_{R} of the managed scoreboard context is updated to WinStart_{B} when:
a difference between WinStart_{R} of a first link and WinStart_{B} of the first link is more than 2¹¹; and
a temporary record of a scoreboard context of the first link exists.

7. The device of claim 1, wherein WinStart_{R} of the managed scoreboard context of a first link is updated to WinStart_{R} of a second link.

8. The device of claim 1, wherein WinStart_{R} of the managed scoreboard context of a first link is updated to WinStart_{R} of a second link when:
a difference between WinStart_{R} of the first link and WinStart_{R} of the second link is more than 2¹¹; and
WinStart_{R} of the second link has been updated.

9. The device of claim 1, wherein a temporary record of the managed scoreboard context for the BA agreement is deleted at an end of a transmission opportunity (TXOP).

10. The device of claim 1, wherein:
the managed scoreboard context is updated per a frame whose at least one of a decryption and an integrity check fails; and
the updated managed scoreboard context rejects frames that pass at least one of the decryption and the integrity check.

11. The device of claim 1, wherein:
the managed scoreboard context is updated per a frame whose at least one of a decryption and an integrity check fails; and
the managed scoreboard context resumes a state from before the update when the managed scoreboard context is updated per the frame whose at least one of the decryption and the integrity check fails.

12. The device of claim 1, wherein:
the managed scoreboard context is updated per a frame whose at least one of a decryption and an integrity check fails; and
the decryption is before a BA scoreboard context.

13. The device of claim 1, wherein:
a reorder buffer of the managed scoreboard context is updated per a frame whose at least one of a decryption and an integrity check fails; and
the decryption is before the reorder buffer.

14. The device of claim 1, wherein:
a reorder buffer of the managed scoreboard context is updated per a frame whose at least one of a decryption and an integrity check fails; and
the reorder buffer resumes a state from before the update when the reorder buffer is updated per the frame whose at least one of the decryption and the integrity check fails.

15. The device of claim 14, wherein the reorder buffer is under a protected BA agreement.

16. The device of claim 1, wherein the BA agreement is negotiated between a first multi-link device (MLD) and a second MLD, and wherein when the second MLD has a separate scoreboard context for each of its links, the second MLD cannot use:
reorder buffer information of the managed scoreboard context to update the managed scoreboard context; and
information of another link's scoreboard context update the managed scoreboard context.

17. The device of claim 1, wherein:
the BA agreement is negotiated between a first MLD and a second MLD; and
a station (STA) of the second MLD implements a partial-state operation for its scoreboard context when the second MLD has a separate scoreboard context for each of its links.

18. The device of claim 1, wherein:
the BA agreement is negotiated between a first MLD and a second MLD; and
a recipient flushes the managed scoreboard context after sending a BA frame and after a TXOP.

19. A system comprising:
a first wireless device, wherein the first wireless device includes a wireless network interface device implemented on one or more integrated circuits (ICs), and wherein the wireless network interface device is configured to:
negotiate a Block Acknowledgement (Ack) (BA) agreement for multiple links, wherein the BA agreement includes a managed scoreboard context and a managed reorder buffer;
transmit frames according to the BA agreement;
a second wireless device, wherein the second wireless device includes another wireless network interface device implemented on one or more other ICs, and wherein the other wireless network interface device is configured to:
negotiate the BA agreement with the first wireless device; and
receive the frames from the first wireless device according to the BA agreement.

20. A method for Block Acknowledgement (Ack) (BA) operations, the method comprising:
negotiating a BA agreement for multiple links, wherein the BA agreement includes a managed scoreboard context and a managed reorder buffer; and
exchanging frames according to the BA agreement.
